(19) United States
(12) Patent Application Publication
(10) Pub. No.: US 2004/0106483 A1
(43) Pub. Date: Jun. 3, 2004

(54) Ratchet type tensioner

(76) Inventors: Isamu Okabe, Osaka (JP); Toshitaka Ogo, Osaka (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/688,465

(22) Filed: Oct. 17, 2003

(30) Foreign Application Priority Data
Nov. 29, 2002 (JP) 2002-347359

(51) Int. Cl. F16H 7/08

(52) U.S. Cl. 474/109; 474/110; 474/101

(57) ABSTRACT

In a ratchet type tensioner comprising a housing, a plunger slidable in, and protruding from, the housing, and biased in a protruding direction, a ratchet mechanism comprising a rack formed on a side surface of the plunger, and a pawl provided on the housing and engageable with the rack to prevent the return movement of the plunger, the pawl is composed of a sintered alloy having a density of at least 7.2 g/cm³. The sintered alloy is formed by warm molding, high temperature sintering, recompression, or combinations thereof, and preferably contains a total of 0.5 to 8 weight % of at least one element from the group consisting of Nickel, Copper and Molybdenum. The balance of the composition of the sintered alloy consists of Iron and impurities. The invention provides a ratchet type tensioner having a high strength and excellent wear resistance at a low cost.

### FIELD OF THE INVENTION

The invention relates to a tensioner used in a chain transmission device mounted on an automobile, motorcycle, or other motor vehicle. More specifically it relates to a ratchet type tensioner, in which a ratchet mechanism is used to limit the backward movement of a plunger.

### BACKGROUND OF THE INVENTION

In the engine of an automobile, motorcycle, or the like, a chain transmission using a roller chain, a silent chain, or the like, is used as a timing mechanism for driving one or more valve-operating cams from the engine crankshaft.

A tensioner is used to absorb elongation of the chain and to impart constant tension to the chain. There are various types of suitable tensioners. A tensioner used in a wide variety of applications is the ratchet type tensioner. In the ratchet type tensioner, a plunger, slidable in a housing, is biased in the protruding direction, and a ratchet mechanism, comprising a pawl on the tensioner housing, engageable with a rack on a side surface of the plunger, prevents return movement of the plunger.

In a ratchet type tensioner, the plunger must have high wear resistance and high durability to avoid the effects of impact and vibration. Thus, in the case of a plunger made from carbon steel (for example, S35C to S45C in JIS G4051) heat treatment, by quenching and tempering, is widely utilized. On the other hand, the pawl, which prevents the backward movement of the plunger, does not directly receive impact. A sintered alloy, having a density of 6.9 to 7.1 g/cm³, is typically used as a material for the pawl because of its low cost.

Recently, due to the trend toward higher engine power, the force applied to the plunger is increased, and a large load is applied to the ratchet mechanism, causing the ratchet mechanism to become worn and damaged. Eventually the ratchet mechanism fails, and is no longer able to prevent return movement of the plunger.

In a direct injection type gasoline engine or a diesel engine, in which fuel is directly injected into the cylinders, carbon soot is generated due to a partial burning phenomenon in which the diffusion of fuel does not progress, and flame transmission discontinues. The carbon soot, which is essentially cinders, enters gaps between the pawl and the rack of the plunger, forming inclusions which cause abrasive wear of the pawl.

Furthermore, when an engine is used over a long period of time without an oil change, impurities such as wear powder and carbon soot enter the deteriorated oil, accelerating the wear of the pawl. In the worst case, breakage of the pawl can lead to engine failure.

For these reasons, in order to improve the durability of the pawl, it has been proposed to form the pawl from a hard alloy steel such as a chromium steel (for example, SCr 420 in JIS 4104), chromium molybdenum steel, or the like. However, the production cost is higher than in the case where a sintered alloy is used. Due to the recent consumer demand for lower prices in motor vehicles and their parts, the trade-off between high strength and high wear resistance on the one hand, and low cost on the other hand, has become a problem requiring urgent attention.

Accordingly, the objects of the invention are to solve the above-mentioned problems of the conventional ratchet type tensioner, and to provide a ratchet type tensioner having high strength and excellent wear resistance at a low cost.

### SUMMARY OF THE INVENTION

The ratchet type tensioner in accordance with the invention is structurally similar to a conventional ratchet-type tensioner, in that it comprises a housing, a plunger slidable in, and protruding from, the housing, and biased in a protruding direction, a ratchet mechanism comprising a rack formed on a side surface of the plunger, and a pawl provided on the housing and engageable with the rack to prevent the return movement of the plunger. To address the problems of the above-described conventional ratchet type tensioner, the pawl is composed of a sintered alloy having a density of at least 7.2 g/cm³. In a preferred embodiment, the sintered alloy is formed by at least one of the steps from the group consisting of warm molding, high temperature sintering and recompression, and contains a total of 0.5 to 8 weight % of at least one element from the group consisting of Nickel, Copper and Molybdenum, and the balance of the composition of the sintered alloy consists of Iron and small quantities of impurities. In most cases, the impurities are indispensable impurities.

The strength and wear resistance of the pawl are improved when the density of the sintered alloy is 7.2 g/cm³ or more, and, even when the tensioner is used in an environment in which dirt and inclusions from a diesel engine, a direct injection engine, or the like, are produced, or where deteriorated oil continues to be used for lubrication, the pawl will reliably prevent backward movement of the plunger of the tensioner over a long period of time.

Although it is not known with certainty why the strength and wear resistance of the pawl were improved by setting the density of the sintered alloy forming a pawl to 7.2 g/cm³ or more, it is believed that the improvement in the strength and wear resistance of the pawl results because increasing the density of the sintered alloy reduces the small porosities existing between metal particles.

When the pawl is composed of a sintered alloy formed by at least one of the steps consisting of warm molding, high temperature sintering and recompression, a uniform sintered body having a density of 7.2 g/cm³ or more can be reproduced, and the strength and wear resistance of the pawl are further enhanced, so that the pawl reliably stops the backward movement of the plunger of the tensioner over a long period of time.

Where the sintered alloy contains a total of 0.5 to 8 weight % of at least one metal from the group consisting of Ni, Cu and Mo, and the balance is Fe and impurities, not only are the strength and wear resistance of the pawl further enhanced, but its corrosion resistance is also enhanced, so that, even in the presence of deteriorated, oxidized oil, the pawl reliably stops the backward movement of the plunger over a long period of time.

Ni (Nickel) improves the strength and toughness in an iron-based matrix and at the same time improves its corrosion resistance. Cu (Copper) generates a liquid phase during sintering, and accelerates the diffusion of the alloy composition, so that the strength and corrosion resistance in the iron-based matrix of the alloy are improved. Furthermore, Mo (Molybdenum) enhances the hardness, strength and temper softening resistance of the iron-based matrix of the alloy. The addition of these metals to a sintered alloy can further improve various properties such as strength, wear resistance, corrosion resistance, toughness, heat resistance and the like in the sintered alloy. Then these elements are present in amounts less than about 0.5 weight % in total, their effects are negligible. On the other hand, when these elements are present in amounts exceeding about 8 weight % in total, their effects become saturated, and further improvements are not realized. Moreover when these elements are present in amounts exceeding about 8 weight % in total, the compressibility of the raw material powder is reduced so that the improvement in the density of the sintered alloy is difficult to obtain.

### BRIEF DESCRIPTION OF THE DRAWINGS

FIG. 1 is a schematic view of a timing chain system using a ratchet type tensioner in accordance with the invention;

FIG. 2 is a table comparing the properties of a conventional pawl and pawls in accordance with the invention; and

FIG. 3 is a graph showing the relationships between the sintering densities and wear ratios of the conventional pawl and the pawls in accordance with the invention.

### DETAILED DESCRIPTION OF THE PREFERRED EMBODIMENTS

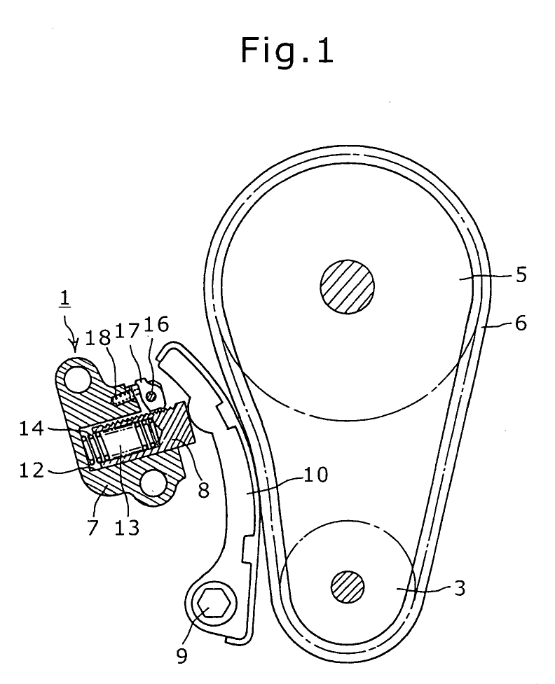

In the ratchet-type tensioner 1 shown in FIG. 1, a plunger 8 fits retractably into a plunger-receiving hole 12 provided in a tensioner housing 7. The plunger is biased in the protruding direction by a spring 14, which is in compression between a bottom surface of the plunger-receiving hole 12 and a bottom surface of a hollow recess 13 in the plunger. This plunger 8 presses against a tensioner lever 10, which, in turn, presses against a timing chain 6, arranged to transmit power from a driving sprocket 5 to a driven sprocket 3. The tensioner thereby maintains proper tension in the chain.

A pawl 17 is engaged with a rack 16 formed on a side surface of the plunger 8. The pawl is pivoted on the tensioner housing 7, and biased into engagement with the rack by a spring 18.

Pawls in the invention were produced from the following iron-based powders:

A: Fe and impurities

B: 4 weight % Ni, 2 weight % Cu, 0.5 weight % Mo, the balance Fe and impurities

C: 2 weight % Ni, 1.5 weight % Mo, the balance Fe and impurities

D: 0.6 weight % Mo, the balance Fe and impurities

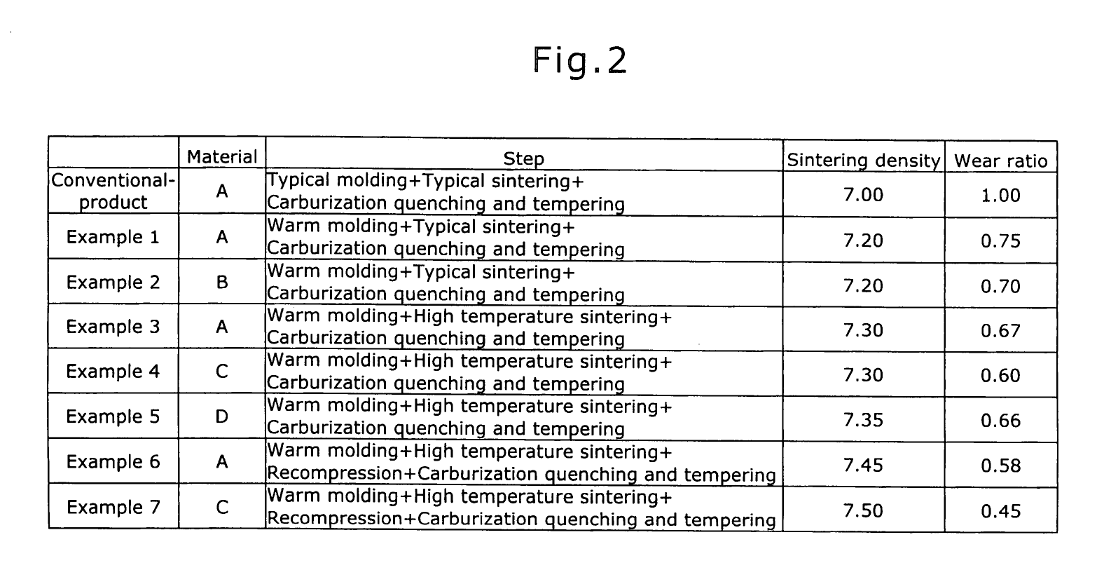

A lubricant and a graphite powder were mixed into each of the above four kinds of iron-based powders. The mixtures were then molded to the shape of a pawl, and then sintered by the sintering steps shown in FIG. 2.

Both typical molding and warm molding were performed at a pressure of 686 MPa. Warm molding was performed by heating at 130° C., and typical sintering was performed at 1130° C. High temperature sintering was performed at 1250° C. in a nitrogen gas atmosphere. In Example 6 and Example 7, after warm molding and high temperature sintering, recompression was performed at a reduced size, of 0.08 mm, to crush porosities in the surface layer of the pawl, so that further densification of the pawl was obtained.

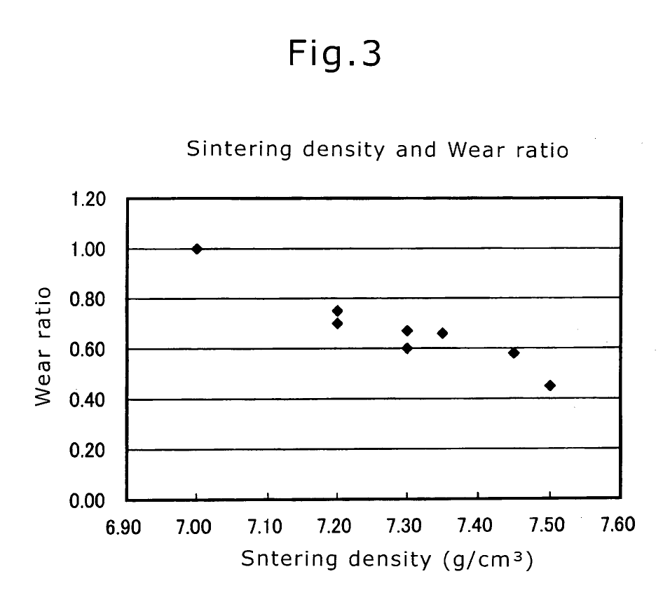

The wear ratios tabulated in FIG. 2 and depicted graphically in FIG. 3, represent the relative wear losses of the respective products of the examples compared to the wear of a conventional product, defined as 1.00.

As apparent from FIGS. 2 and 3, in the products of Examples 1 to 7, each having a sintered density of 7.2 g/cm³ or more, the wear loss was reduced by 25 to 65% as compared with the conventional product.

In Examples 2 and 4, at least one metal from the group consisting of Ni, Cu and Mo was contained in a sintered alloy in an amount from 0.5 to 8 weight %. Examples 1 and 3 contained no such metals and have the same sintering densities as Examples 2 and 4, respectively. As can be seen from the comparison in FIG. 2, Examples 2 and 4 exhibit less wear loss, compared to Examples 1 and 3, respectively.

To improve their strength and wear resistance, the pawls of the conventional Example and Examples 1 to 7 were subjected to carburization quenching and tempering.

The tensioner according to the invention is particularly useful in the timing chain system of an engine, especially when subjected to severe conditions such as high temperatures and an oxidizing atmosphere. The tensioner, however, is also applicable to various other uses in transmission mechanisms such as carrier systems, elevators and the like.

As described above in detail when a pawl in a ratchet type tensioner is composed of a sintered alloy having a density of at least 7.2 g/cm³, its strength and wear resistance are improved. The tensioner may be used in an environment in which dirt and inclusions from a diesel engine, a direct injection engine, or the like, are produced, or where deteriorated oil continues to be used for lubrication. Even under such adverse conditions, wear of the pawl can be reliably suppressed over a long period of time.

If the pawl composed of a sintered alloy, having a density of at least 7.2 g/cm³ is formed by at least one of the steps from the group consisting of warm molding, high temperature sintering and recompression, a uniform sintered body having can be reproduced, and the strength and wear resistance of the pawl are further enhanced. Additionally, since warm molding, high temperature sintering and recompression can be carried out in conventional installations, special capital investment is not needed. Therefore, the ratchet type tensioner of the invention is also significantly advantageous from the standpoint of production cost, when compared with conventional ratchet type tensioners having pawls made from alloy steel by forging, machining and the like.

In addition, where the sintered alloy contains a total of 0.5 to 8 weight % of at least one metal from the group consisting of Ni, Cu and Mo, and the balance is Fe and impurities, not only are the strength and wear resistance of the pawl enhanced, but the corrosion resistance of the pawl is also enhanced. Consequently wear of the pawl is reliably suppressed over a long period of time even in the presence of deteriorated, oxidized, oil.

What is claimed is:

1. A ratchet type tensioner comprising a housing, a plunger slidable in, and protruding from, the housing, and biased in a protruding direction, a ratchet mechanism comprising a rack formed on a side surface of the plunger, and a pawl provided on the housing and engageable with the rack to prevent the return movement of the plunger, wherein the pawl is composed of a sintered alloy having a density of at least 7.2 g/cm³.

2. The ratchet type tensioner according to claim 1, wherein said sintered alloy is formed by at least one of the steps from the group consisting of warm molding, high temperature sintering and recompression.

3. The ratchet type tensioner according to claim 1, wherein said sintered alloy contains a total of 0.5 to 8 weight % of at least one element from the group consisting of Nickel, Copper and Molybdenum, and the balance of the composition of the sintered alloy consists of Iron and impurities.

4. The ratchet type tensioner according to claim 2, wherein said sintered alloy contains a total of 0.5 to 8 weight % of at least one element from the group consisting of Nickel, Copper and Molybdenum, and the balance of the composition of the sintered alloy consists of Iron and impurities.
